(19) United States
(12) Patent Application Publication
(10) Pub. No.: US 2012/0110066 A1
(43) Pub. Date: May 3, 2012

(54) IMAGE INPUT METHOD, CONTENT ITEM SERVER, AND RELAY SERVER

(75) Inventors: Yasuhiro Furuta, Suwa-gun (JP); Yasuhiro Oshima, Matsumoto-shi (JP)

(73) Assignee: Seiko Epson Corporation, Shinjuku-ku (JP)

(21) Appl. No.: 13/283,513

(22) Filed: Oct. 27, 2011

(30) Foreign Application Priority Data
Oct. 29, 2010 (JP) 2010-242976

(51) Int. Cl. G06F 15/16

(52) U.S. Cl. 709/203

(57) ABSTRACT

An image input system includes a client, a content item server, a relay server, and an image input apparatus. When the client receives an instruction to input an image, the client transmits a first input request including the address of the content item server to the relay server and the relay server transmits a second input request to the image input apparatus. The image input apparatus inputs the image and transmits the image to the relay server. The relay server transmits the image to the address included in the first input request. The content item server stores the image in a predetermined storage location inside a storage unit.

### CROSS REFERENCES TO RELATED APPLICATIONS

The entire disclosure of Japanese Patent Application No. 2010-242976, filed on Oct. 29, 2010, is incorporated by reference herein.

### BACKGROUND

1. Technical Field

The present invention relates to a technique for inputting an image via a network.

2. Related Art

In recent years, techniques for outputting an image from a printer connected to a network such as the Internet have been suggested (see JP-A-2003-271356, JP-A-2003-8569, and JP-A-2010-157208). Further, techniques for inputting an image from a scanner connected to a network have been suggested (see JP-A-2010-114946 and JP-A-2009-278420).

According to the related art, however, a print-dedicated or scan-dedicated application (or a driver) installed in a client has to be used to use a printer or a scanner connected to a network. Therefore, the burden on the client is large.

### SUMMARY

An advantage of some aspects of the invention is that it provides a technique for reducing the burden on a client when an image input via a network.

Aspects of the invention can be embodied in the following forms or the following applications.

### Application 1

According to an aspect of the invention, there is provided an image input method of an image input system including a client, a content item server, a relay server, and an image input apparatus connected to each other via a network. The image input method includes: transmitting information indicating an address of the relay server to the client, when the content item server receives an information request from the client; transmitting a first input request including an address of the content item server to the relay server corresponding to the address of the relay server, when the client receives an instruction to input an image; transmitting a second input request to the image input apparatus, when the relay server receives the first input request from the client; inputting the image and transmitting the input image to the relay server, when the image input apparatus receives the second input request from the relay server; transmitting the received image to the address included in the first input request, when the relay server receives the image from the image input apparatus; and storing the received image in a predetermined storage location inside a storage unit, when the content item server receives the image from the relay server.

With such a configuration, when the client receives the instruction to input the image, the relay server acquires the image from the image input apparatus and stores the image in the content item server. Therefore, since the image can be input without depending on the software environment or the hardware environment of the client, the burden on the client can be reduced.

### Application 2

In the image input method described in Application 1, the client may include a browse request transmission unit transmitting an information request to the content item server. The content item server may include an information transmission unit transmitting information indicating an address of the relay server to the client, when receiving an information request from the client. A first input request transmission unit of the client may receive the information from the content item server, acquire the address of the relay server from the information, and transmit the first input request to the address.

With such a configuration, since the client can acquire the address of the relay server from the content item server, the address of the relay server can be accurately grasped.

### Application 3

In the image input method described in Application 2, the information may include information indicating the storage location of the content item server. The first input request transmission unit of the client may receive the information from the content item server, acquire the address of the relay server and the storage location from the information, and transmit the address of the content item server and the first input request including the storage location to the address.

With such a configuration, since the client can acquire the information indicating the storage location of an image from the content item server, the relay server can accurately be notified of the storage location.

### Application 4

In the image input method described in Application 3, the first input request transmission unit of the client may transmit the first input request using an address in which the address of the relay server, the address of the content item data, and the storage location are connected.

With such a configuration, an output request can be transmitted by the HTTP request message used as a standard of the Internet by using the connected addresses.

### Application 5

In the image input method described in any one of Application 1 to Application 4, the first image transmission unit of the relay server may generate a preview image of the image and transmit the preview image to the client before transmitting the received image to the address. The client may include a preview image display unit displaying the preview image when receiving the preview image from the relay server.

With such a configuration, the client can confirm the preview image of the image input by the image input apparatus.

### Application 6

In the image input method described in any one of Application 1 to Application 5, the relay server may include a standby page transmission unit transmitting a standby page indicating a standby state to the client from transmission of the second input request to the image input apparatus by the second input request transmission unit until the first image reception unit receives the image. The client may include a standby page display unit displaying the standby page when receiving the standby page from the relay server.

With such a configuration, even when the time necessary for inputting the image by the image input apparatus is necessary, it is possible to confirm the standby state from the client.

### Application 7

In the image input method described in any one of Application 1 to Application 6, the second input request transmission unit of the relay server may receive designation of an image input apparatus inputting the image from the client and then transmit the second input request to the designated image input apparatus after reception of the first input request from the client before transmitting the second input request to the image input apparatus.

With such a configuration, the client can input the image to any image input apparatus.

### Application 8

In the image input method described in Application 7, the relay server may further includes a database indicating a corresponding relationship between a serial number allocated to the image input apparatus when the image input apparatus is manufactured and an image input apparatus identifier uniquely allocated to the image input apparatus by the relay server. The second input request transmission unit of the relay server may receive designation of the image input apparatus by the image input apparatus identifier from the client and identify the image input apparatus which is the transmission destination of the second input request by the serial number corresponding to the received image input apparatus identifier.

With such a configuration, the image input from the image input apparatus can be stored in the content item server while concealing the serial number of the image input apparatus from the content item server.

### Application 9

In the image input method described in any one of Application 1 to Application 8, the first image transmission unit of the relay server transmits the received image, and then transmits the address of the content item server included in the first input request to the client.

With such a configuration, the client can receive the address of the content item server from the relay server again without separately storing the address of the content item server. Therefore, after the transmission of the first input request, the page provided by the content item server can accurately be displayed.

According to another aspect of the invention, there are provided a content item server, a relay server, or an image input apparatus as well as the above-described image input method. Further, there may be provided a content item output system or a computer program. The computer program may be stored in a computer-readable recording medium or may be a computer program for the entire system, a computer program for the content item server, or a computer program for the relay server.

For example, there is provided a input image system including a client, a content item server, a relay server, and an image input apparatus connected to each other via a network. The client includes a reception unit receiving an instruction to input an image and a first input request transmission unit transmitting a first input request including the address of the content item server to the relay server when receiving the instruction to input the image. The relay server includes a second input request transmission unit transmitting a second input request to the image input apparatus when receiving the first input request from the client, a first image reception unit receiving the image from the image input apparatus, and a first image transmission unit transmitting the received image to the address included in the first input request. The content item server includes a second image reception unit receiving the image from the relay server and a storage unit storing the received image in a predetermined storage location. The image input apparatus includes an input request reception unit receiving the second input request from the relay server, an image input unit inputting the image when receiving the second input image, and a second image transmission unit transmitting the input image to the relay server.

### BRIEF DESCRIPTION OF THE DRAWINGS

The invention will be described with reference to the accompanying drawings, wherein like numbers reference like elements.

FIG. 1 is a diagram illustrating the general configuration of a content item output system.

FIG. 2 is a diagram illustrating an example of a printer database.

FIG. 3 is a diagram illustrating an example of a client database.

FIG. 4 is a diagram illustrating an example of a print job database.

FIG. 5 is a diagram illustrating an example of a scan job database.

FIG. 6 is a diagram illustrating the sequence of a printer registration process.

FIG. 7 is a diagram illustrating an example in which a printer ID is printed on a printing sheet.

FIG. 8 is a diagram illustrating an example in which a printer registration page is displayed.

FIG. 9 is a diagram illustrating the sequence of a content item output process.

FIG. 10 is a diagram illustrating an example in which a web page of a content item server is displayed.

FIG. 11 is a diagram illustrating an example of a printer selection page.

FIG. 12 is a diagram illustrating an example in which a print reception completion page is displayed.

FIG. 13 is a diagram illustrating the sequence of a scan process.

FIG. 14 is a diagram illustrating an example of a printer selection page.

FIG. 15 is a diagram illustrating an example of a preview standby page.

FIG. 16 is a diagram illustrating an example of a preview confirmation page.

FIG. 17 is a diagram illustrating an example in which an upload completion page is displayed.

FIG. 18 is a diagram illustrating a page used to designate an arbitrary print content item.

### DESCRIPTION OF EXEMPLARY EMBODIMENTS

Hereinafter, an embodiment of the invention will be described in the following order.

### A. Configuration of Content Item Output System

### B. Printer Registration Process

### C. Content Item Output Process

### D. Scan Process

### E. Modified Examples

### A. Configuration of Content Item Output System

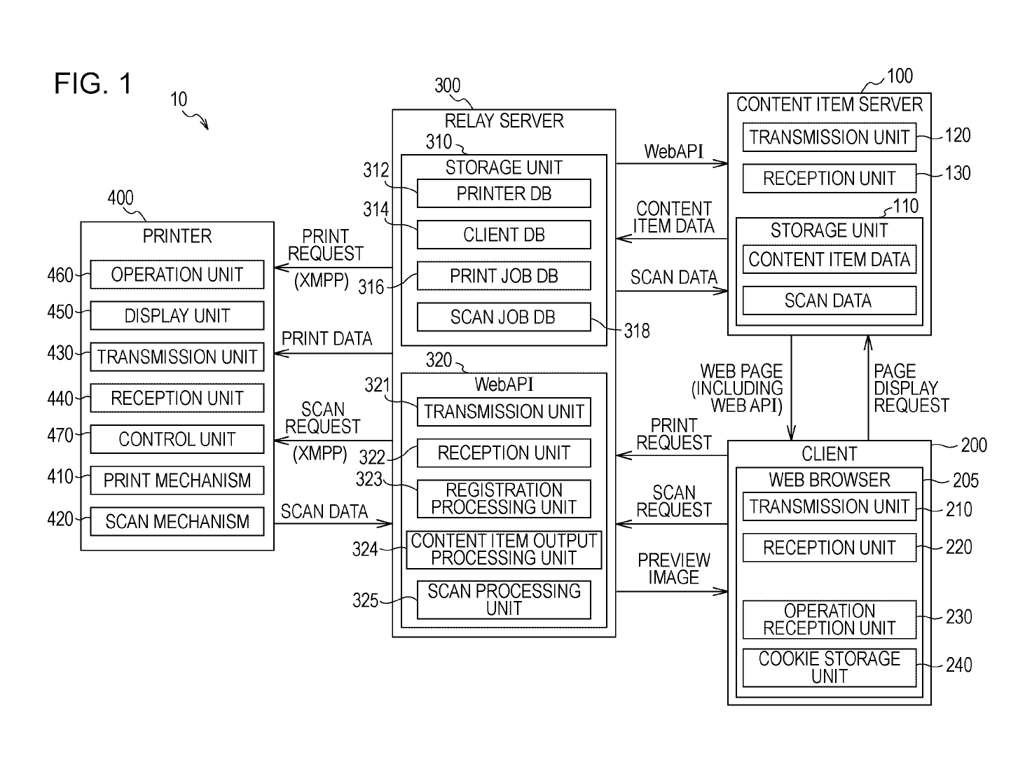

FIG. 1 is a diagram illustrating the general configuration of a content item output system according to an embodiment of the invention. In a content item output system 10, a content item server 100, a client 200, a relay sever 300, and a printer 400 having a scan function are connected to each other via a network such as the Internet. The content item output system 10 according to this embodiment has a function of allowing a printer 400 to print a content item stored in the content item server 100 via the relay server 300 in response to an instruction from the client 200. Further, the content item output system 10 according to this embodiment has a function of transmitting (uploading) an image read through a scan function of the printer 400 to the content item server 100 via the relay server 300 in response to an instruction from the client 200. That is, the content item output system 10 according to this embodiment also has a function of an image input system which inputs an image from the printer 400 serving as an image input apparatus. All of the functions can be used through a user interface provided to a web browser 205 installed in the client 200.

The content item server 100 is a computer including a CPU or a memory and functions as a web server. The content item server 100 includes a storage unit 110, a transmission unit 120, and a reception unit 130. The storage unit 110 stores, as content item data, various web pages described in accordance with HTML or image data representing coupons, maps, or the like. Further, the storage unit 110 stores, as scan data, an image read through the scan function of the printer 400. The transmission unit 120 transmits various request/response messages from or to the client 200 or the relay server 300 in accordance with HTTP (Hyper Text Transfer Protocol). The reception unit 130 receives the various request/response messages from the client 200 or the relay server 300 in accordance with HTTP.

The client 200 is a computer including a CPU, a memory, a monitor, or the like and functions as a web client. For example, the client 200 can be configured by a personal computer, a net-book, a mobile phone, a portable terminal, a portable music player, a game console, a television, or the like connectable to a network. Since the web browser 205 is installed as a web client program in the client 200, a transmission unit 210, a reception unit 220, an operation reception unit 230, a cookie storage unit 240 shown in the drawing are realized through the function of the web browser 205. The transmission unit 210 transmits various request/response messages from or to the content item server 100 or the relay server 300 in accordance with HTTP. The reception unit 220 receives the various request/response messages from the content item server 100 or the relay server 300 in accordance with HTTP. The operation reception unit 230 receives various operations from a user using a GUI (Graphical User Interface) on a web page received from the content item server 100. The cookie storage unit 240 has a function of storing cookie information issued from the content item server 100 or the relay server 300.

The relay server 300 is a computer including a CPU or a memory and functions as a web server. The relay server 300 includes a storage unit 310. The storage unit 310 stores a printer database 312, a client database 314, a print job database 316, and a scan job database 318. These databases will be described in detail below. A web API program (hereinafter, simply referred to as “Web API”) 320 is installed in the rely server 300. Therefore, when the web API is executed, the web API functions as a transmission unit 321, a reception unit 322, a registration processing unit 323, a content item output processing unit 324, and a scan processing unit 325. The web API refers to an application programming interface which can provide various functions to a web page of a third person via the Internet. In this embodiment, the print function or the scan function realized using the printer 400 is provided on the web page delivered from the content item server 100. Specifically, the function is provided by linking URLs (Uniform Resource Locators) of execution files of the web API to various buttons (or anchor tags) in the web page delivered from the content item server 100.

The transmission unit 321 transmits various request/response messages from or to the content item server 100, the client 200, or the printer 400 in accordance with HTTP. In this embodiment, the transmission unit 321 transmits some of the instructions for the printer 400 in accordance with not HTTP but XMPP (eXtensible Messaging and Presence Protocol). The reception unit 322 receives the various request/response messages from the content item server 100, the client 200, or the relay server 300 in accordance with HTTP.

The registration processing unit 323 is a program module which realizes a printer registration process described below and has a function of registering the printer 400 used by the user of the client 200. The content item output processing unit 324 is a program module which realizes a content item output process described below and has a function of allowing the printer 400 to print content item data stored in the content item server 100 in response to an instruction from the user using the client 200. The scan processing unit 325 is a program module which realizes a scan process described below and has a function of allowing the printer 400 to scan an image and uploading the scanned image to the content item server 100 in response to an instruction from the user using the client 200.

The printer 400 is a printer for a multi-function apparatus having a scanner therein and includes a print mechanism 410, a scan mechanism 420, a transmission unit 430, a reception unit 440, a display unit 450, an operation unit 460, and a control unit 470.

The print mechanism 410 is a mechanism which performs printing on a printing sheet by driving a printing head. The scan mechanism 420 is a mechanism which acquires image data by driving a CCD image sensor.

The transmission unit 430 transmits various request/response messages from or to the relay server 300 in accordance with HTTP. The reception unit 440 receives the various request/response messages from the relay server 300 in accordance with HTTP. In this embodiment, the reception unit 440 has a function of receiving some of the instructions for the printer 400 in accordance with not HTTP but XMPP (eXtensible Messaging and Presence Protocol).

The display unit 450 displays the operation statuses of the printer 400, the scanned image, or the like. The operation unit 460 includes operation buttons or the like used to give various instructions for the printer 400. The control unit 470 controls the print mechanism 410, the scan mechanism 420, the transmission unit 430, the reception unit 440, the display unit 450, the operation unit 460 described above.

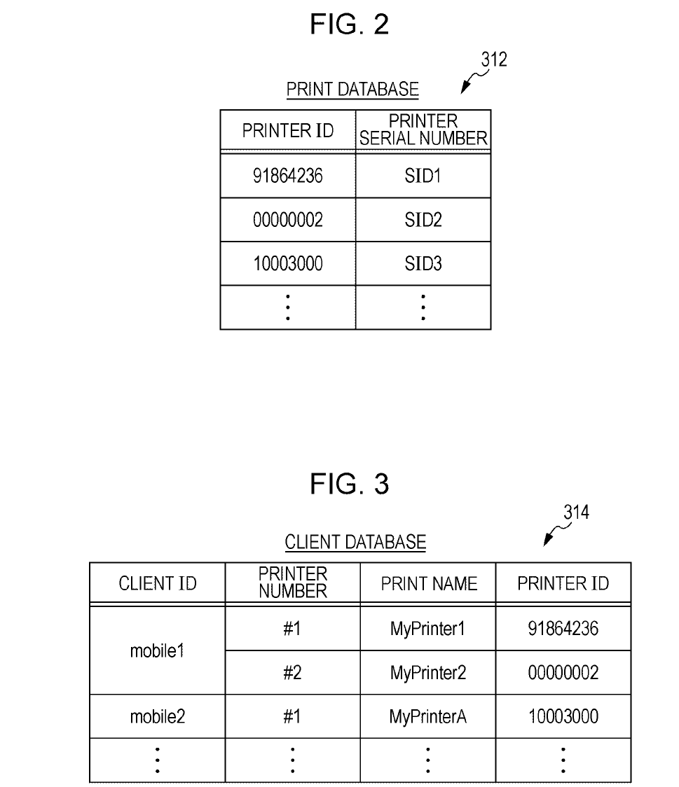

FIG. 2 is a diagram illustrating an example of the printer database 312 stored in the storage unit 310 of the relay server 300. In the printer database 312, printer IDs and printer serial numbers correspond to each other and are stored. The printer ID is identification information which is uniquely allocated to the printer 400 of the user from the relay server 300 in the printer registration process described below. The printer serial number is a number which is specifically allocated to an individual printer from a manufacturer of the printer 400 when the printer 400 is manufactured.

FIG. 3 is a diagram illustrating an example of the client database 314 stored in the storage unit 310 of the relay server 300. In the client database 314, client IDs, printer numbers, printer names, and the printer IDs (see FIG. 2) correspond to each other and are stored. The client ID is identification information of which the client 200 is notified as cookie information from the relay server 300 when the client 200 accesses the relay server 300. The client ID is stored in the cookie storage unit 240 of the client 200 through a function of the web browser 205. The printer number is a number which can individually be allocated to the printer name and the printer ID. The printer name is the name of the printer 400 which is arbitrarily designated from the user in the printer registration process described below.

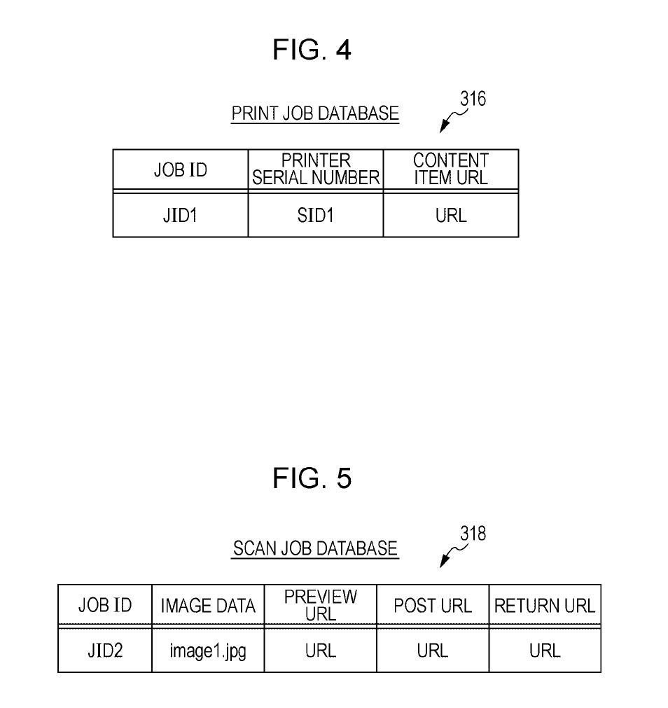

FIG. 4 is a diagram illustrating an example of the print job database 316 stored in the storage unit 310 of the relay server 300. In the print job database 316, a job ID which can be specifically allocated for each print job, the printer serial number (see FIG. 2) of the printer 400 which is in charge of the printing, and a content item URL which is a storage location of a content item to be printed correspond to each other and are stored.

FIG. 5 is a diagram illustrating an example of the scan job database 318 stored in the storage unit 310 of the relay server 300. In the scan job database 318, a job ID which can specifically be allocated for each scan job, image data which is read by the printer 400, a preview URL which indicates the storage location of a preview image generated from the image data, a post URL which is the storage location of a transmission destination of the image data, and a return URL which indicates the URL of a return destination in the page browser correspond to each other and are stored.

### B. Printer Registration Process

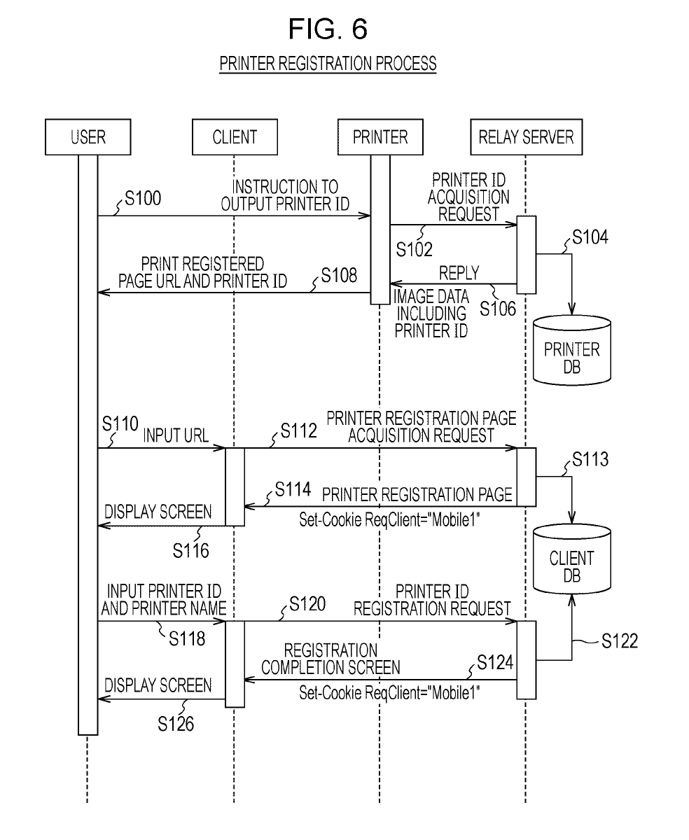

FIG. 6 is a diagram illustrating the sequence of the printer registration process performed to register the printer 400 in the relay server 300 which is the printing destination of a content item. In the printer registration process, the user first operates the operation unit 460 of the printer 400 to give an instruction to print the printer ID (see FIGS. 2 and 3) (step S100). Then, the printer 400 transmits a printer ID acquisition request to the relay server 300 by an HTTP request message (step S102). The printer 400 includes a printer serial number stored in a memory thereof in this request message.

The relay server 300 issues the printer ID when the relay server 300 receives the printer ID acquisition request from the printer 400. The printer ID may have any value as long as the value is a value which is not the same as another printer ID. When the relay server 300 issues the printer ID, the relay server 300 allows the printer serial number included in the above-described acquisition request to correspond to the issued printer ID and records the serial number and the printer serial number in the printer database 312 (see FIG. 2) (step S104).

When the relay server 300 completely records the serial number and the printer serial number in the printer database 312, the relay server 300 generates an image representing the issued printer ID and transmits the image to the printer 400 by an HTTP response message (step S106). When the printer 400 receives the response message, the printer 400 prints a predetermined message including the image (printer ID) in the received response message by controlling the print mechanism 410 (step S108). The reason for the printer ID to be represented by the image is to prevent the printer ID from being intercepted easily by a third person since information is normally exchanged with plain text in HTTP.

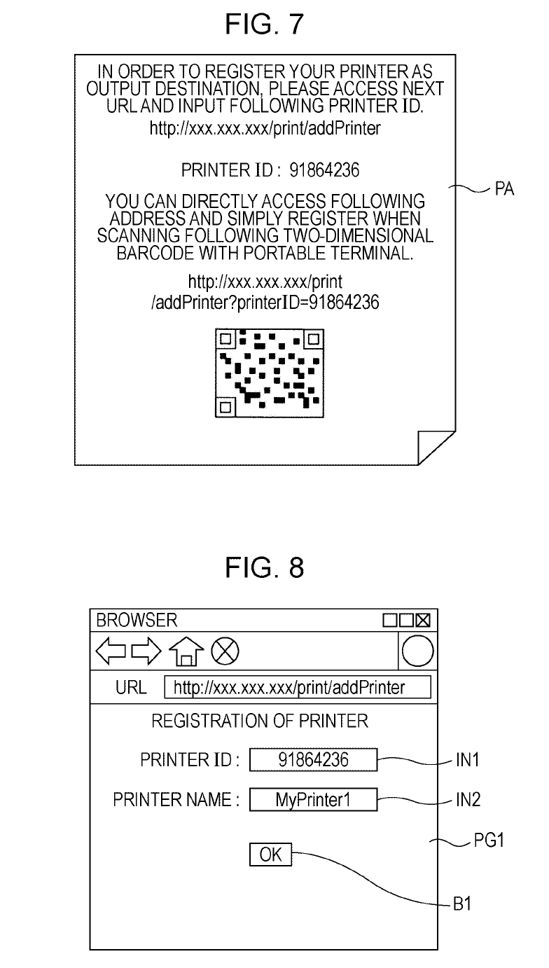

FIG. 7 is a diagram illustrating an example in which the printer ID is printed in a printing sheet PA. As illustrated in the drawing, a URL (URL of the relay server 300) of a page (printer registration page) used to register the printer and the printer ID received from the relay server 300 are printed on the printing sheet PA. In this embodiment, a two-dimensional barcode generated by encoding the URL of the printer registration page and the printer ID is also printed.

When the two-dimensional barcode is printed, it is easy to access the relay server 300 by analyzing the two-dimensional barcode by the client 200 including a camera. In this embodiment, the printer ID and the URL of the relay server 300 are printed in the printing sheet PA. However, the printer ID and the URL of the relay server 300 may be displayed on the display unit 450 of the printer 400.

Next, the user inputs the URL (URL of the relay server 300) of the printer registration page printed on the printing sheet PA shown in FIG. 7 into the web browser 205 of the client 200 (step S110). Then, a printer registration page acquisition request is transmitted as the HTTP request message from the client 200 to the relay server 300 (step S112). When the relay server 300 receives this acquisition request from the client 200, the relay server 300 generates a unique client ID of the client 200 and stores the client ID in the client database 314 (step S113). Then, the relay server 300 transmits the printer registration page stored in advance in the storage unit 310 as an HTTP response message to the client 200 (step S114). At this time, the relay server 300 simultaneously transits the generated client ID as cookie information to the client 200. When the client 200 receives the printer registration page and the cookie information from the relay server 300, the client 200 displays the printer registration page on the web browser 205 (step S116) and stores the cookie information in the cookie storage unit 240.

FIG. 8 is a diagram illustrating an example in which the printer registration page is displayed on the web browser 205. As shown in the drawing, an input section IN1 used to input a printer ID, an input section IN2 used to input a printer name, and an OK button B1 are formed on a printer registration page PG1.

When the printer registration page PG1 is displayed on the web browser 205, the user inputs the printer ID printed on the printing sheet PA and an arbitrary printer name on the printer registration page PG1 and presses down the OK button B1 (step S118). Then, the client 200 transmits the printer ID registration request to the relay server 300 by the HTTP request message (step S120). The printer ID registration request includes the printer ID and the printer name input on the printer registration page PG1.

When the printer ID registration request is transmitted, the client ID stored in the cookie storage unit 240 is also transmitted as cookie information from the client 200 to the relay server 300.

When the relay server 300 receives the printer ID registration request and the cookie information, the relay server 300 first determines whether the client ID included in the received cookie information is identical with the client ID recorded in advance in the client database 314. When the relay server 300 does not receive the cookie information or receives the cookie information which is not registered in the client database 314, the relay server 300 determines that an error occurs and transmits, as a reply, a web page indicating that the printer 400 may not be registered to the client 200. On the other hand, when the client ID included in the received cookie information is identical with the client ID recorded in advance in the client database 314, the relay server 300 records the printer ID and the printer name received from the client 200 by associating the printer ID and the printer name with the corresponding client ID of the client database 314 (step S122). Then, a web page indicating that the registration of the printer 400 is completed is replied to the client 200 (step S124). At this time, the client ID is transmitted again as the cookie information to the client 200. Then, the client 200 displays the received web page and stores the received cookie information in the cookie storage unit 240 (step S126).

Through the printer registration process described above, the printer database 312 shown in FIG. 2 and the client database 314 are constructed in the relay server 300. As a consequence, the printer 400 registered in the printer registration page PG1 can be used in a content item output process or a scan process described below.

### C. Content Item Outputting Process

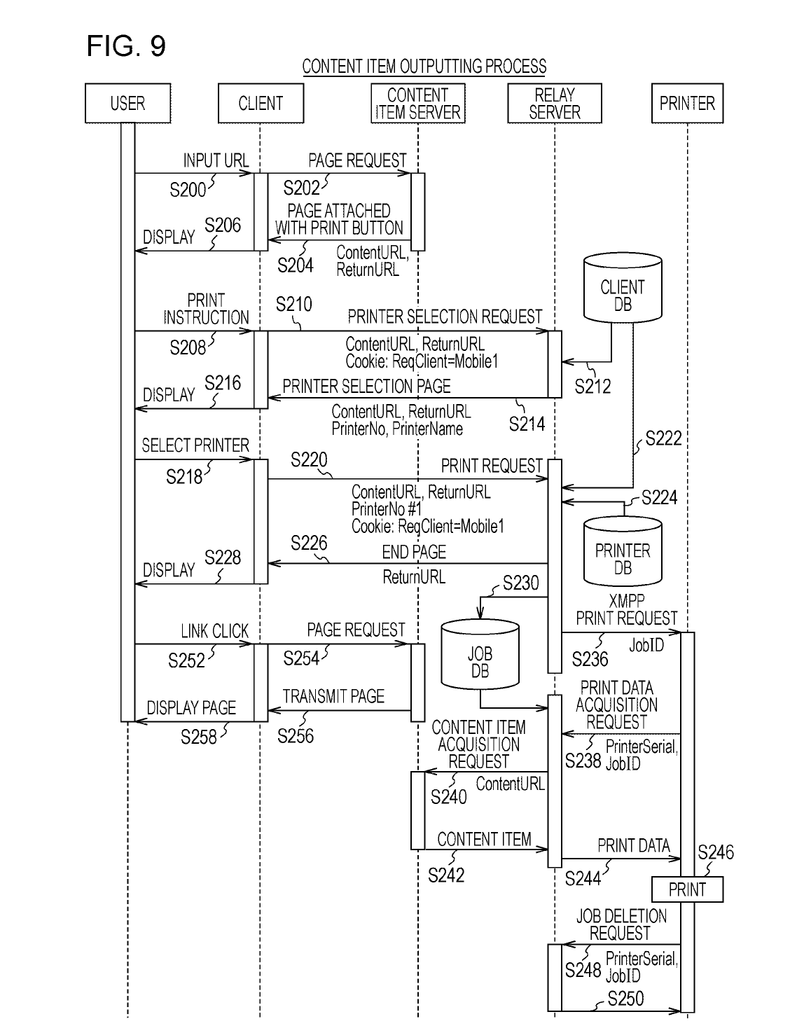

FIG. 9 is a diagram illustrating the sequence of the content item output process of outputting a content item stored in the content item server 100 from the printer 400. In the content item output process, a user first operates the web browser 205 of the client 200 to input the URL of a web page stored in the content item server 100 (step S200). Then, a web page browsing request is transmitted by an HTTP request message from the client 200 to the content item server 100 (step S202). The content item server 100 transmits a web page with a print button stored in the storage unit 110 to the client 200 by an HTTP response message (step S204). In the print button in the web page, the URL of the relay server 300, a content item URL indicating the location of a print content item in the content item server 100, and a return URL indicating the URL (in this embodiment, the URL of the content item server 100) of a web site displayed after the content item output process can be associated with each other. When the client 200 receives the web page from the content item server 100, the client 200 displays the web page on the web browser 205 (step S206).

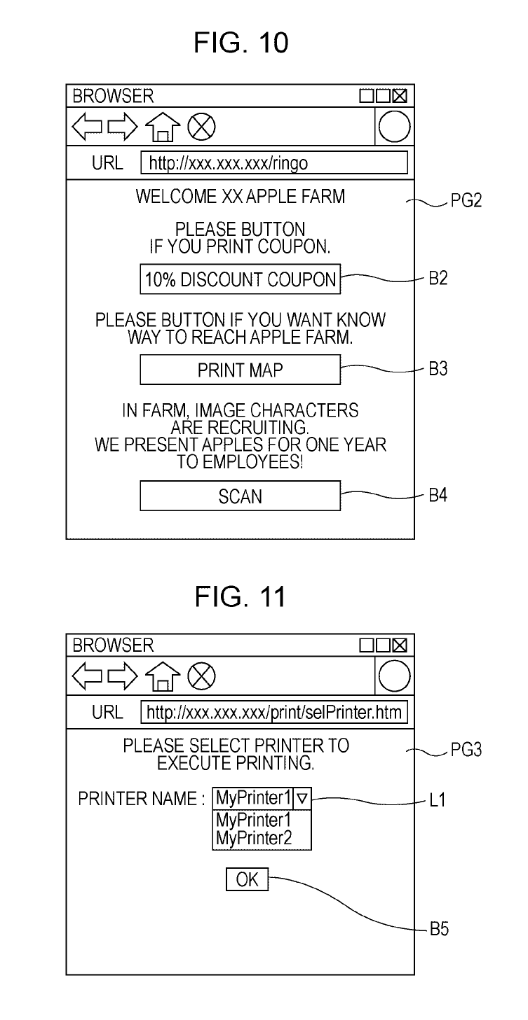

FIG. 10 is a diagram illustrating an example in which the web page of the content item server 100 is displayed on the web browser 205 of the client 200. A print button B2 used to print a coupon, a print button B3 used to print a map, and a scan button B4 used to scan and upload an image are formed in the web page PG2. The following URL (1) including a URL representing the storage location of image data indicating a coupon as the storage location of the print content item is linked to the print button B2. A URL including a URL representing the storage location of image data indicating a map as the storage location of the print content item is linked to the print button B3. The details of the scan button B4 will be described below.

“http”//(URL of Relay Server 300)/print?contentURL=http://xxx.xxx.xxx/ringo/coupon.jpg?re turnURL=http://xxx.xxx.xxx/” (1)

When the web page PG2 of the content item server 100 is displayed on the web browser 205, the user presses down the print button corresponding to a desired print content item to give a print instruction (step S208). Then, a request (printer selection request) for selecting the printer 400 outputting the print content item and the cookie information stored in the cookie storage unit 240 of the client 200 through the above-described printer registration process are transmitted from the client 200 to the relay server 300 (step S210). At this time, for example, when the user presses down the print button B2, a printer selection request is transmitted from the client 200 to the URL (1) mentioned above.

In this embodiment, when the user presses down the print button B2, the printer selection request is transmitted to the URL to which the URL of the relay server 300, the content item URL (here, http://xxx.xxx.xxx/ringo/coupon.jpg), and the return URL (here, http://xxx.xxx.xxx/) are connected to each other by an identifier “?”. Further, “print” in the above URL (1) refers to the file name of a program module for realizing the content item output processing unit 324.

When the relay server 300 receives the printer selection request and the cookie information from the client 200, the relay server 300 acquires the printer name and the printer number corresponding to the client ID included in the cookie information with reference to the client database 314 (step S212) and generates a web page (printer selection page) for selecting the printer based on the printer name and the printer number. Then, the generated printer selection page is replied as an HTTP response message to the client 200 (step S214). When the client 200 receives the printer selection page, the client 200 displays the printer selection page on the web browser 205 (step S216).

FIG. 11 is a diagram illustrating an example of the printer selection page. As shown in the drawing, a list L1 of printers registered through the above-described printer registration process by the user and an OK button B5 are formed in a printer selection page PG3. The list L1 is generated by specifying the client IDs based on the cookie information received from the client 200 and listing the printer names of all the printers corresponding to the client IDs in the client database 314. Each printer number can be made to correspond to the printer name of the list L1. Further, the URL of the relay server 300, the content item URL included in the printer selection request received from the client 200, and the return URL can be made to correspond to the OK button B5.

When the printer selection page PG3 is displayed on the web browser 205, the user selects one printer outputting the print content item in the list L1 and presses down the OK button B5 (step S218). Then, a print request and the cookie information are transmitted by the HTTP request message from the client 200 to the relay server 300 (step S220). At this time, the printer selection request is transmitted from the client 200 to the following URL (2). The URL (2) includes the URL of the relay server 300, the content item URL, the return URL, and the printer number of the printer selected in the printer selection page PG3 by the user.

“http://(URL of Relay Server 300)/print?contentURL=http://xxx.xxx.xxx/ringo/coupon.jpg?re turnURL=http://xxx.xxx.xxx/?printerNo=#1” (2)

When the relay server 300 receives the print request and the cookie information from the client 200, the relay server 300 specifies the printer ID corresponding to the printer number included in the print request and the client ID included in the cookie information with reference to the client database 314 (step S222). Then, the relay server 300 also specifies the printer serial number corresponding to the printer ID with reference to the printer database 312 (step S224).

When the printer serial number is specified in this way, different processes are performed in the relay server 300 and the client 200. First, a process performed in the client 200 will be described. After the relay server 300 specifies the printer serial number, the relay server 300 transmits a print reception completion page, in which a link to the return URL included in the print request received from the client 200 is described, to the client 200 by the HTTP response message (step S226). When the client 200 receives the print reception completion page, the client 200 displays the print reception completion page to the web browser 205 (step S228).

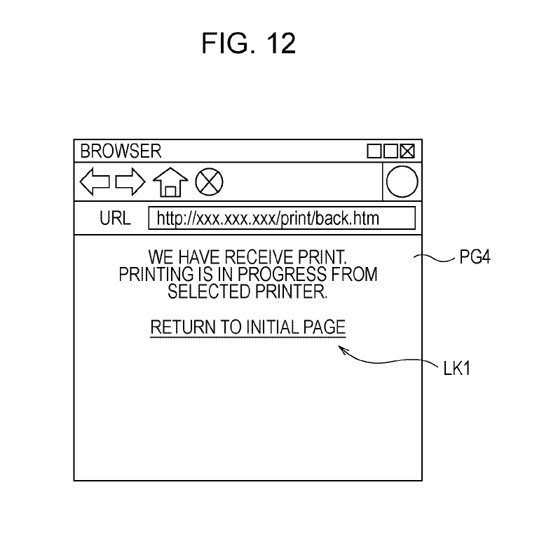

FIG. 12 is a diagram illustrating an example in which a print reception completion page PG4 is displayed on the web browser 205 of the client 200. The print reception completion page PG4 includes a message indicating reception of printing and a link LK1 to the return URL.

When the user clicks the link LK1 in the print reception completion page PG4 shown in FIG. 12 (step S252), a page display request is transmitted by the HTTP request message to the return URL (in this embodiment, the URL of the content item server 100) which is the link destination (step S254). When the content item server 100 receives the page display request, the content item server 100 replies with the web page PG2 (see FIG. 10) stored in the storage unit 110 by the HTTP response message (step S256). Then, the web page PG2 is displayed on the web browser 205 of the client 200 (step S258). Further, when there is no explicit instruction from the user in the print reception completion page PG4, a tag or a script for redirecting the display page may be included in the return URL. In this way, the display screen is switched to the web page PG2 of the content item server 100 without special operation of the user.

Next, a process performed in the relay server 300 after the printer serial number is specified will be described. After the relay server 300 specifies the printer serial number, the relay server 300 allocates a unique job ID to the printer serial number and the content item URL included in the print request received in step S220 and registers the printer serial number, the content item URL, and the job ID in the print job database 316 (see FIG. 4) (step S230). Then, the print request including the job ID is transmitted to the printer 400 corresponding to the printer serial number specified in step S224 based on XMPP (step S236). XMPP refers to a communication protocol standardized in RFC 3920 and 3921 by IETF (Internet Engineering Task Force) and a protocol mainly used in an instant messenger. In XMPP, since any message of the XML format can be transmitted to another apparatus in real time, communication control of high responsiveness can be realized compared to HTTP in which a request and a response have to be necessarily paired. In this embodiment, the print request is transmitted from the relay server 300 to the printer 400 by XMPP, but may be transmitted by HTTP.

When the printer 400 receives the print request to the printer serial number of the printer 400 by XMPP, the printer 400 transmits a print data acquisition request the including the job ID included in the print request and the printer serial number of the printer 400 to the relay server 300 which is the transmission source by the HTTP request message (step S238). When the relay server 300 receives the print data acquisition request from the printer 400, the relay server 300 specifies the content item URL corresponding to the job ID and the printer serial number included in the print data acquisition request from the print job database 316. Then, the print content item acquisition request is transmitted by the HTTP request message to the content item URL (step S240).

When the content item server 100 receives the print content item acquisition request from the relay server 300, the content item server 100 transmits a print content item stored in the content item URL by the HTTP response message (step S242). When the relay server 300 receives the print content item from the content item server 100, the relay server 300 converts the data format of the received print content item into print data (for example, JPEG) which the printer 400 can process, and then transmits the print data to the printer 400 by the HTTP response message (step S244). When the printer 400 receives the print data from the relay server 300, the printer 400 performs printing by controlling the print mechanism 410 in accordance with the print data (step S246). When the printing is completed, the printer 400 transmits a job deletion request including the job ID and the printer serial number of the printer 400 to the relay server 300 by the HTTP request message (step S248). When the relay server 300 receives the job deletion request, the relay server 300 deletes the job corresponding to the job ID and the printer serial number included in the job deletion request. Then, the printer 400 is notified of a message indicating the deletion of the job by the HTTP response message (step S250).

According to the above-described content item output process, an administrator of the content item server 100 can output the content item using the printer 400 without depending on a hardware environment or a software environment of the client 200 by just providing the web page PG2 (see FIG. 10) operated by the administrator with the user interface (the print buttons B2 and B3) including the link to the relay server 300. Therefore, it is not necessary to connect the printer to the client 200 and it is not necessary to install a printer driver in the client 200. Accordingly, the burden on the client 200 can be reduced. As a consequence, the client 200 is not limited to a personal computer. As long as an apparatus can browse a web, any apparatus such as a net-book, a portable terminal, a portable music player, a game console, a television, a reproducing apparatus, a recording apparatus, or the like can be applied. In this embodiment, the print function of the printer 400 can be used by just operating the user interface on the web browser 205. Therefore, the user may not execute an application or a driver for using the print function. Accordingly, the printer can be used through a very simple operation.

Through the above-described content item output process, the control of the printer 400 or the conversion of the data format of the content item is performed by the relay server 300. Therefore, a content item provider may not prepare a structure for controlling the printer 400 in the content item server 100. Accordingly, each user can post the print content item on his or her web page easily without considering different print environments.

Further, in the above-described content item output process, the printer serial number unique to the printer 400 is registered to the relay server 300, but the content item server 100 is not notified of the printer serial number. Accordingly, it is not necessary to inform the content item provider that is a third person of the presence of the printer 400 and a system with high security can be provided.

### D. Scan Process

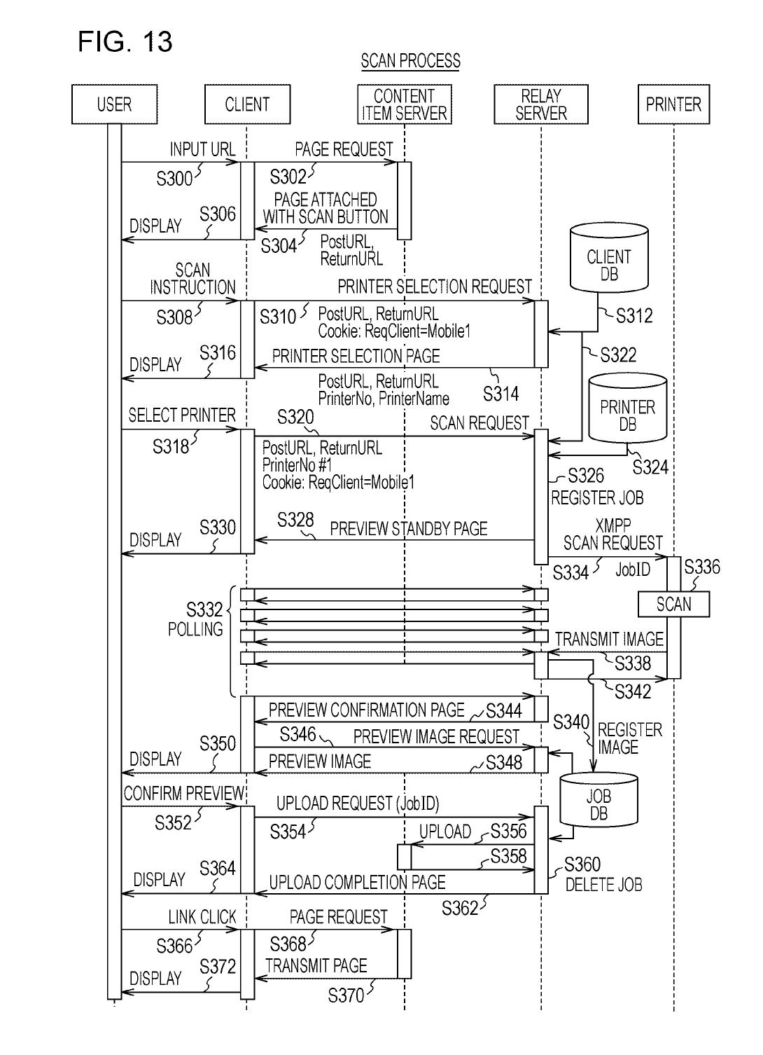

FIG. 13 is a diagram illustrating the sequence of a scan process of uploading an image scanned by the printer 400 to the relay server 300. In the scan process, first, a user operates the web browser 205 of the client 200 to input the URL of the web page PG2 stored in the content item server 100 (step S300). Then, a web page PG2 browsing request is transmitted by the HTTP request message from the client 200 to the content item server 100 (step S302). The content item server 100 transmits the web page PG2 with a scan button stored in the storage unit 110 to the client 200 by the HTTP response message (step S304). The URL of the relay server 300, the post URL representing the destination to which the scanned image is transmitted, and the return URL indicating the URL (in this embodiment, the URL of the content item server 100) of the web site displayed after the scan process can be associated with the scan button of the web page PG2. Specifically, the following URL (3) in which the URL of the relay server 300, the post URL representing the destination to which the scanned image is transmitted, and the URL of the web site displayed after the scan process are connected to each other can be associated as a link. When the client 200 receives the web page PG2 from the content item server 100, the client 200 displays the web page PG2 on the web browser 205 (step S306). FIG. 10 shows an example in which the scan button B4 provided to upload an image character image generated by the user is formed.

“http://(URL of Relay Server 300)/scan?postURL=http://xxx.xxx.xxx/storage?returnURL=http://xxx.xxx.xxx/” (3).

When the web page PG2 of the content item server 100 is displayed on the web browser 205, the user presses down the scan button B4 to give a scan instruction (step S308). Then, a request (printer selection request) for selecting the printer 400 scanning an image and the cookie information stored in the cookie storage unit 240 of the client 200 through the above-described printer registration process are transmitted from the client 200 to the relay server 300 (step S310). At this time, for example, the printer selection request is transmitted from the client 200 to the above URL (3).

In this embodiment, when the user presses down the scan button B4, the printer selection request is transmitted to the URL to which the URL of the relay server 300, the post URL (here, http://xxx.xxx.xxx/storage), and the return URL (here, http://xxx.xxx.xxx/) are connected to each other by an identifier “?”. Further, “scan” in the above URL (3) refers to the file name of a program module for realizing the scan processing unit 325.

When the relay server 300 receives the printer selection request and the cookie information from the client 200, the relay server 300 acquires the printer name and the printer number corresponding to the client ID included in the cookie information with reference to the client database 314 and generates a web page (printer selection page) for selecting the printer based on the printer name and the printer number (step S312). Then, the generated printer selection page is replied as an HTTP response message to the client 200 (step S314). When the client 200 receives the printer selection page, the client 200 displays the printer selection page on the web browser 205 (step S316).

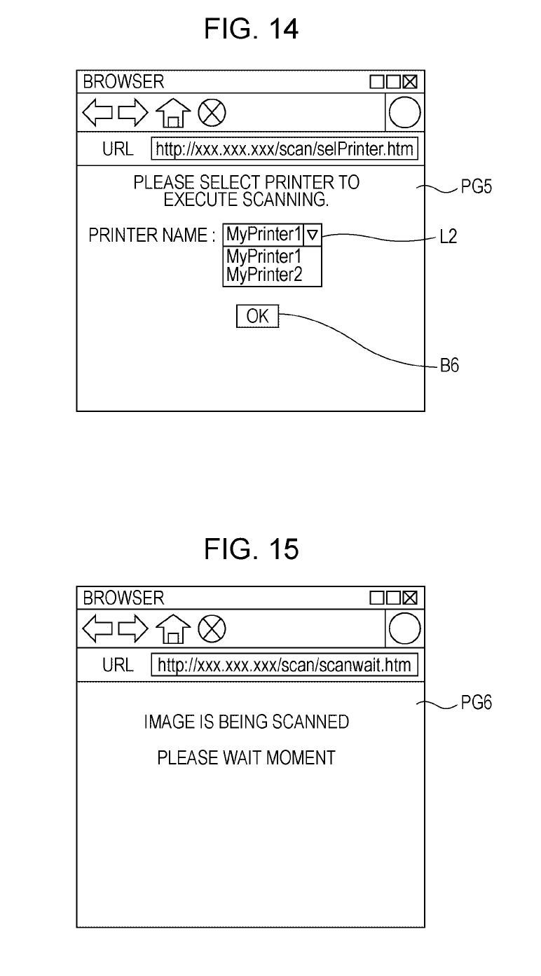

FIG. 14 is a diagram illustrating an example of the printer selection page. A printer selection page PG5 is nearly identical with the printer selection page PG3 shown in FIG. 11. The printer number can be made to correspond to each printer name of a list L2. The URL of the relay server 300 and the post URL and the return URL included in the printer selection request received from the client 200 can be made to correspond to an OK button B6.

When the printer selection page PG5 is displayed on the web browser 205, the user selects one printer performing scanning in the list L2 and presses down the OK button B6 (step S318). Then, a scan request and the cookie information are transmitted by the HTTP request message from the client 200 to the relay server 300 (step S320). At this time, the printer selection request is transmitted from the client 200 to the following URL (4). The URL (4) includes the URL of the relay server 300, the post URL, the return URL, and the printer number of the printer selected in the printer selection page by the user.

“http://(URL of Relay Server 300)/scan?postURL=http://xxx.xxx.xxx/storage?returnURL=http://xxx.xxx.xxx/?printerNo=#1” (4)

When the relay server 300 receives the print request and the cookie information from the client 200, the relay server 300 specifies the printer ID corresponding to the printer number included in the print request and the client ID included in the cookie information with reference to the client database 314 (step S322). Then, the relay server 300 also specifies the printer serial number corresponding to the printer ID with reference to the printer database 312 (step S324). After the relay server 300 specifies the printer serial number, the relay server 300 allocates a unique job ID to the printer serial number and the post URL included in the scan request received in step S320 and registers the job ID, the printer serial number, and the post URL in the scan job database 318 (see FIG. 5) (step S326).

When the scan job is registered in the scan job database 318 in this way, different processes are performed in the relay server 300 and the client 200. First, a process performed in the client 200 will be described. After the registration of the job, the relay server 300 transmits a web page (preview standby page) for standing by the reception of the preview image including the job ID to the client 200 by the HTTP response message (step S328). When the client 200 receives the preview standby page, the client 200 displays the preview standby page on the web browser 205 (step S328).

FIG. 15 is a diagram illustrating an example of the preview standby page. As shown in the drawing, for example, a message “IMAGE IS BEING SCANNED. PLEASE WAIT MOMENT” is displayed on a preview standby page PG6. The preview standby page PG6 includes tags or scripts of which screens are automatically reloaded every few seconds. Therefore, an inquiry (polling) for whether the preview image is generated is made periodically from the client 200 to the relay server 300 (step S330).

When the preview standby page PG6 is reloaded, the relay server 300 is notified of the job ID by the HTTP request message. The relay server 300 retransmits the preview standby page PG6 until the image corresponding to the job ID is registered in the scan job database 318.

Next, a process performed in the relay server 300 after the registration of the job will be described. During the polling from the client 200, the relay server 300 first transmits the scan request including the job ID to the printer 400 corresponding to the printer serial number specified in step S324 based on XMPP (step S334). In this embodiment, the scan request is transmitted from the relay server 300 to the printer 400 by XMPP, but may be transmitted by HTTP.

When the printer 400 receives the print request to the printer serial number of the printer 400 by XMPP, the printer 400 scans the image by controlling the scan mechanism 420 (step S336). Both image data regarding the scanned image and the job ID are transmitted to the relay server 300 by the HTTP request message (step S338). When the relay server 300 receives the image data and the job ID from the printer 400, the image data and the job ID are made to correspond to each other and are registered in the scan job database 318 (step S340). At this time, the preview image obtained by reducing the received image data is generated and stored in the storage unit 310. The stored URL of the preview image is registered as a preview URL in the scan job database 318. When the image data and the preview URL are registered in the scan job database 318, the relay server 300 notifies the printer 400 that the image data is normally received by the HTTP response message (step S342).

When the scanned image data and the preview URL are registered in the scan job database 318 in this way, the relay server 300 transmits, as a response of the polling from the client 200 in step 332, a preview confirmation page including the job ID and the preview URL by the HTTP response message (step S344). When the client 200 receives the preview confirmation page, the client 200 gives a request for transmitting the preview image to the relay server 300 based on the preview URL included in the page (step S346). When the relay server 300 receives the request for transmitting the preview image from the client 200, the relay server 300 transmits the preview image stored in the designated preview URL to the client 200 (step S348). When the client 200 receives the preview image from the relay server 300 through the above-described process, the client 200 locates the preview image in the preview confirmation page and displays the preview image on the web browser 205 (step S350).

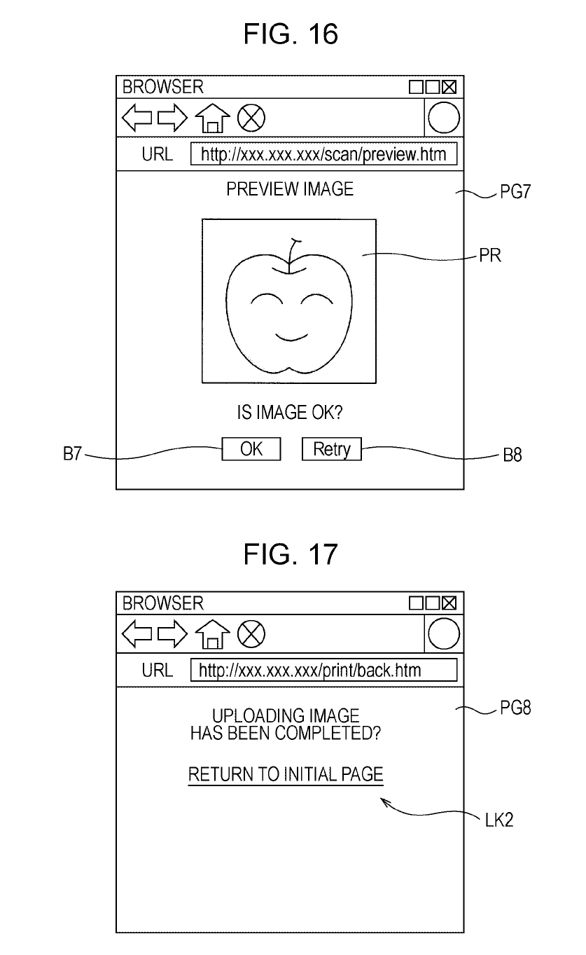

FIG. 16 is a diagram illustrating an example of the preview confirmation page. As shown in the drawing, a preview image PR, an OK button B7, and a retry button B8 are displayed on a preview confirmation page PG7. When the retry button B8 is pressed down in this page, the same request as the scan request of step S320 is transmitted by the HTTP request message from the client 200 to the relay server 300. Therefore, an image is scanned again by the printer 400. On the other hand, when the OK button B7 is pressed down, the client 200 transmits an image upload request to the relay server 300 by the HTTP request message (step S360). The image upload request includes the job ID.

When the relay server 300 receives the image upload request from the client 200, the relay server 300 acquires an image corresponding to the job ID included in the image upload request from the scan job database 318. The image is transmitted by the HTTP request message to the post URL (in this embodiment, the content item server 100) registered in the scan job database 318 (step S356). When the content item server 100 receives the transmitted image, the content item server 100 stores the image in the storage unit 110 of the content item server 100 and transmits, as a response, a storage completion notification indicating that the storage of the image is completed to the relay server 300 by the HTTP response message (step S358). When the relay server 300 receives the storage completion notification from the client 200, the relay server 300 deletes the corresponding job from the scan job database 318 (step S360). An upload completion page indicating that the upload is completed is transmitted to the client 200 by the HTTP response message (step S362). The upload completion page includes the return URL registered in the scan job database 318. When the client 200 receives the upload completion page, the client 200 displays the upload completion page on the web browser 205 (step S364).

FIG. 17 is a diagram illustrating an example in which the upload completion page is displayed on the web browser 205 of the client 200. An upload completion page PG8 includes a message indicating that the upload is completed and a link LK2 to the return URL. When the user clicks the link LK2 in the upload completion page PG8 shown in FIG. 17 (step S366), a page display request is transmitted to the return URL (in this embodiment, the URL of the content item server 100), which is the link destination, by the HTTP request message (step S368). When the content item server 100 receives the page display request, the content item server 100 transmits the web page PG2 (see FIG. 10) stored in the storage unit 110 as a response by the HTTP response message (step S370). Then, the web page PG2 is displayed on the web browser 205 of the client 200 (step S372). Further, the upload completion page PG8 may include a tag or a script redirecting the display page to the return URL even when there is no explicit instruction from the user. In this way, the display screen is converted into the web page PG2 of the content item server 100 without a special operation of the user.

Through the above-described scan process according to this embodiment, the administrator of the content item server 100 can scan the image using the printer 400 without depending on the hardware environment or the software environment of the client 200 by just providing the web page PG2 (see FIG. 10) operated by the administrator with the user interface (the scan button B4) including the link to the relay server 300. Therefore, it is not necessary to connect the printer (scanner) to the client 200 and it is not necessary to install a scanner driver in the client 200. Accordingly, the burden on the client 200 can be reduced. As a consequence, the client 200 is not limited to a personal computer. As long as an apparatus can browse a web, any apparatus such as a net-book, a portable terminal, a portable music player, a game console, a television, a reproducing apparatus, a recording apparatus, or the like can be applied. In this embodiment, the scan function of the printer 400 can be used by just operating the user interface on the web browser 205. Therefore, the user may not execute an application for using the scan function. Accordingly, the scanner can be used through a very simple operation.

Through the above-described scan process, the control of the printer 400 and the generation of the preview image are performed by the relay server 300. Therefore, a content item provider may not prepare a structure for controlling the scan function of the printer 400 in the content item server 100. Accordingly, each user can include the scan function of the image on his or her web page easily without considering different scan environments.

Further, in the above-described scan process, the printer serial number unique to the printer 400 is registered to the relay server 300, but the content item server 100 is not notified of the printer serial number. Accordingly, it is not necessary to inform the content item provider that is a third person of the presence of the printer 400 and a system with high security can be provided.

In the above-described scan process, the scanned image is finally stored in the content item server 100, but the stored image may be used in various forms. For example, anybody may browse or download the stored image through the web browser 205 of the client 200 or may only the administrator of the content item server 100 may browse or download the stored image. Of course, only a person permitted in advance may browse or download the stored image by restricting the browsing or the downloading.

### E. Modified Examples

Hitherto, one embodiment of the invention has been described, but the invention is not limited to this embodiment. Instead, the invention may be modified in various forms without departing from the gist of the invention. For example, the content item output system 10 according to the embodiment can perform both the content item output process and the scan process, but may perform only one of the content item output process and the scan process. Further, the following modifications or a combination thereof are possible.

### Modified Example 1

In the content item output system 10 according to the above-described embodiment, a print content item stored in the content item server 100 is output by the printer 400. On the other hand, the content item output system 10 may output the print content item present in any URL designated from the client 200 or may allow the printer 400 to output the print content item (for example, image data) stored in the client 200.

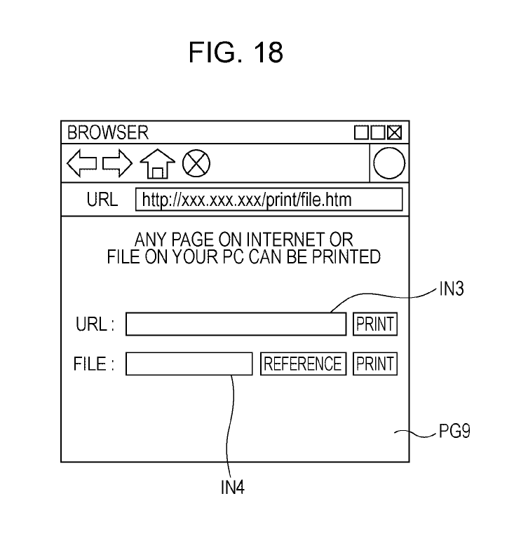

FIG. 18 is a diagram illustrating a page used to designate any print content item according to Modified Example 1. A web page PG9 shown in the drawing is displayed by inputting a predetermined URL of the relay server 300 into the web browser 205. An input section IN3 for designating an URL and an input section IN4 for designating a path stored in the print content item are formed. When the user inputs the URL or the path of the print content item into the input section IN3 or IN4, the input URL or the input print content item is transmitted to the relay server 300. When the relay server 300 acquires the URL from the web page PG9, printing can be performed through the same process as the above-described content item output process by treating this URL as the content item URL acquired in step S210 of the above-described content item output process. When the relay server 300 acquires the data of the print content data time from the web page PG9, printing can be performed through the same process as the above-described content item output process by treating the print content item as the print content item acquired in step S242 of the above-described content item output process.

### Modified Example 2

In the above-described embodiment, the printing or scanning is performed using the printer 400 for a multi-function apparatus in which a printer and a scanner are integrally formed. However, the printer and the scanner may be separated from each other. In this case, in the above-described printer registration process, the printer and the scanner are individually registered in the printer database 312.

### Modified Example 3

In the content item output process according to the above-described embodiment, the output destination of the content item is set to be the printer 400. On the other hand, the content item may be output from various output apparatuses such as a projector or a television. In the scan process according to the above-described embodiment, an image is input through the scan function of the printer. However, an image may be input by various image input apparatuses such as a digital camera, a web camera, a mobile phone, or a portable terminal.

### Modified Example 4

In the content item output process according to the above-described embodiment, when the content item server 100 receives the page browsing request from the client 200 in step S202 described above, user authentication may be performed based on a user ID or a password. In this way, only a permitted user can perform printing. Further, based on the user authentication, a user performing printing may be specified and charging may be performed based on the amount of printing. Furthermore, in the above-described scan process, charging may also be performed based on the user authentication or the amount of scanning.

### Modified Example 5

In the above-described embodiment, a printing or scanning operation is received via the web browser 205 installed in the client 200. Accordingly, such an operation can be received in any form by a program or an apparatus capable of executing communication in accordance with HTTP. For example, a dedicated application (widget) printing a coupon may be installed in the client 200 (for example, a mobile phone) and a printing or scanning operation can be received through the application. In this case, in the dedicated application, the URL of the relay server 300, the content item URL, the post URL, and the return URL may be set in advance. Thus, step S200 to step S206 of the above-described content item output process (FIG. 9) or step S300 to step S306 of the scan process (FIG. 13) may not be performed.

### Modified Example 6

In the content item output process or the scan process according to the above-described embodiment, the client 200 is identified based on the cookie information stored in the web browser 205 of the client 200. However, the cookie information may not essentially be used, but the client 200 may be identified based on another information. For example, the client may be identified based on an environment variable of the client 200 added to the HTTP request message. For example, the environment variable includes a web browser of the client, the kind/version of operating system, an IP address of the client, a host name, and a port number. Further, when the client 200 is a mobile phone, the telephone number is also included in the environment variable.

### Modified Example 7

In the content item output process or the scan process according to the above-described embodiment, when the print button or the scan button is pressed down on the web browser 205 of the client 200, a printer selection page is normally provided and displayed from the relay server 300. On the other hand, for example, when the number of printers registered by a user is only one or when the relay server is notified of the designation of the printer in response to the pressing of the print button or the scan button, the relay server 300 may cancel the providing of the printer selection page. Thus, when the print button or the scan button is pressed down on the web page provided from the content item server 100, no page is provided from the relay server 300 to the client 200 and the printing or scanning immediately starts. Accordingly, the user can perform the printing or the scanning more simply.

What is claimed is:

1. An image input method of an image input system including a client, a content item server, a relay server, and an image input apparatus connected to each other via a network, the image input method comprising:
transmitting information indicating an address of the relay server to the client, when the content item server receives an information request from the client;
transmitting a first input request including an address of the content item server to the relay server corresponding to the address of the relay server, when the client receives an instruction to input an image;
transmitting a second input request to the image input apparatus, when the relay server receives the first input request from the client;
inputting the image and transmitting the input image to the relay server, when the image input apparatus receives the second input request from the relay server;
transmitting the received image to the address included in the first input request, when the relay server receives the image from the image input apparatus; and
storing the received image in a predetermined storage location inside a storage unit, when the content item server receives the image from the relay server.

2. A content item server of an image input system including a client, the content item server, a relay server, and an image input apparatus connected to each other via a network, comprising:
an information transmission unit transmitting information indicating an address of the relay server to the client, when receiving an information request from the client;
an image reception unit receiving an image from the relay server; and
a storage unit storing the received image.

3. A relay server of an image input system including a client, a content item server, the relay server, and an image input apparatus connected to each other via a network, comprising:
an input request transmission unit transmitting a second input request to the image input apparatus, when receiving a first input request from the client;
an image reception unit receiving an image from the image input apparatus; and
an image transmission unit transmitting the received image to an address included in the first input request.

4. The relay server according to claim 3, wherein the image transmission unit transmits the received image by designating a storage location of the content item server included in the first input request.

5. The relay server according to claim 4, wherein the image transmission unit transmits the received image by designating the storage location extracted from an address which is included in the first input request and in which an address of the relay server, an address of the content item data, and the storage location are connected.

6. The relay server according to claim 3, wherein before transmitting the received image to the address, the image transmission unit generates a preview image of the received image and transmits the preview image to the client.

7. The relay server according to claim 3, further comprising:
a standby page transmission unit transmitting a standby page indicating a standby state to the client from transmission of the second input request to the image input apparatus by the input request transmission unit until the image reception unit receives the image.

8. The relay server according to claim 3, wherein the input request transmission unit receives, from the client, designation of the image input apparatus inputting the image and transmits the second input request to the designated image input apparatus after reception of the first input request from the client before transmitting the second input request to the image input apparatus.

9. The relay server according to claim 8, further comprising:
a database indicating a corresponding relationship between a serial number allocated to the image input apparatus when the image input apparatus is manufactured and an image input apparatus identifier uniquely allocated to the image input apparatus by the relay server,
wherein the input request transmission unit receives designation of the image input apparatus by the image input apparatus identifier from the client and identifies the image input apparatus which is a transmission destination of the second input request by the serial number corresponding to the received image input apparatus identifier.

10. The relay server according to claim 3, wherein the image transmission unit transmits the received image and then transmits an address of the content item server included in the first input request to the client.
